(19) United States
(12) Patent Application Publication
(10) Pub. No.: US 2026/0252545 A1
(43) Pub. Date: Aug. 27, 2026

(54) DISTRIBUTED ONLINE AND OFFLINE PROCESSING

(71) Applicant: Walmart Apollo, LLC, Bentonville, AR (US)

(72) Inventors: Abdus KHAN, Santa Clara, CA (US); Zhihao HUANG, Hayward, CA (US); Songjie HUANG, Santa Clara, CA (US); Afroza ALI, Los Altos, CA (US)

(73) Assignee: Walmart Apollo, LLC, Bentonville, AR (US)

(21) Appl. No.: 19/061,856

(22) Filed: Feb. 24, 2025

(51) Int. Cl. G06F 16/23; G06F 16/2457; G06F 16/27

(52) U.S. Cl. CPC G06F 16/2308; G06F 16/24578; G06F 16/27

(57) ABSTRACT

A device may receive a plurality of retrieval sets, first sampling parameters, and second sampling parameters that are based on offline sampling that uses multiple-metric efficacy values that are based on one or more efficacy metrics and one or more policy metrics. The plurality of retrieval sets may be from a plurality of clusters of a set of object embeddings representative of a plurality of objects. The device may select a retrieval set of the plurality of retrieval sets by performing online sampling using the first sampling parameters. The device may determine an object ranking in the retrieval set by performing online sampling using the second sampling parameters. The device may generate code or markup based on the object ranking in the retrieval set.

### BACKGROUND

Online processing involves real-time data handling and computer processing. In online processing, a server may receive request messages from a user device over a network, and the server may generate and transmit response messages to the user device, over the network, to satisfy the requests of the user device. The user device may repeatedly transmit request messages if the response messages from the server contain insufficient, irrelevant, or otherwise unsatisfactory data with respect to the user device's requests. This cycle of request and response uses significant computing resources of the server and the user device in connection with message generation, as well as significant network resources in connection with message communication.

### SUMMARY

As described above, online processing involves the real-time handling and processing of data. In online processing, a server may manage requests from user devices. When a user device sends a request message over a network, the server processes this request and generates a response message. This response is then transmitted back to the user device to fulfill its request. For example, the user device may request a resource (e.g., a web page) containing particular data, and the server may generate the data and respond with the resource containing the data. However, if the response contains insufficient, irrelevant, or otherwise unsatisfactory data, the user device may repeatedly send additional request messages until its demands are fully met. For example, the user device may request a different resource and/or different data. In a particular example, this may involve the user device repeatedly requesting different web pages because web pages previously served to the user device contain low-quality data. This continuous cycle of request and response requires substantial computing power from both the server and the user device for generating and processing messages, and additionally requires significant network resources to handle the communication of these messages.

Thus, producing relevant data for the user device can minimize multiple requests and responses, thereby conserving computing resources and network resources that would otherwise be expended. However, generating accurate and highly relevant data may require significant computing resources and time, which presents problems in online settings having limited computing resources and strict latency requirements. For example, compute-intensive applications demand substantial computing power due to the complexity and volume of data they handle, and often involve complex algorithms and large-scale data processing, which require significant computational resources to execute efficiently.

In one example, generating a cloud infrastructure configuration is a compute-intensive task due to the vast array of possible options and parameters that must be considered. Each configuration involves selecting from numerous cloud infrastructure objects, such as processing resource types, speeds, and quantities, memory resource types and sizes, storage resource types and capacities, networking infrastructure (e.g., load balancers or firewalls) and bandwidth allocations, backup and recovery configurations (e.g., automated backup schedules and data replication services), application services (e.g., container orchestration or serverless computing), and database service configurations as to performance, scalability, and redundancy, among other examples. The sheer volume of potential combinations requires extensive computational resources to evaluate and optimize for specific needs. As another example, generating a set of item recommendations is a compute-intensive task due to the significant amount of interaction data and item attributes that are analyzed to identify patterns and preferences. This is exacerbated when item recommendations are multi-tiered, such as when there are multiple groups of candidate items, and a recommendation must first select which group of candidate items is most relevant, and then identify which items within the selected group are most relevant.

Online systems may have insufficient computing resources to devote to compute-intensive tasks, such as the examples above. As a result, online systems may sacrifice data quality for efficiency, leading to low-quality outputs. Accordingly, an online system may respond to a request from a user device or other system with insufficient, irrelevant, or otherwise unsatisfactory data (e.g., a non-viable cloud infrastructure configuration or irrelevant recommendations), which may fail to incorporate one or more policies that result in the preferred outcomes of interactions between the online system and the user device or other system, thereby resulting in the user device or other system making additional requests to the online system. An online system may also direct or prompt the user device to send additional requests to the online system in order to produce a preferred outcome because the online system may expect that its response is likely insufficient. In order to direct or prompt the user device to send the additional requests, the online system may need to include additional data and/or code in the network message(s) that include the response, which increases the size of those messages, and/or send additional network messages that include the additional data and/or code necessary to prompt or direct the user device to send the additional requests. Similarly, an online system may send follow-up responses to user devices when the preferred outcomes do not result from an original response. The cumulative effect of this results in the consumption of significant processing resources, power resources, and network resources by the online system and the user device in connection with generating and communicating additional requests and responses that help produce a preferred outcome.

Systems and techniques described herein employ distributed online and offline processing of compute-intensive tasks to reduce the processing resources, power resources, and network resources utilized by online systems and user devices by using policy-based data biasing. In some implementations, a task that uses distributed online and offline processing may relate to the selection of objects from a vast array of possible objects. For example, distributed online and offline processing may be used to select cloud infrastructure objects for a cloud infrastructure configuration, or to select objects for recommendation. In some implementations, an offline processing system may perform offline embedding generation for the possible objects, clustering of the embeddings, and sampling (e.g., Thompson sampling) from the clusters to determine a retrieval set of the objects (e.g., representing a smaller subset of all the possible objects) and sampling parameters for use in online processing. This can be done for multiple different object groups (e.g., a cloud compute resource object group and a cloud database service object group, etc., or a groceries object group and a sports equipment object group, etc.) to produce multiple retrieval sets. Generating these elements offline enables significant processing resources to be devoted to producing high-quality data, thereby reducing the online processing burden needed to produce such high-quality data.

For example, an online processing system may use the retrieval sets and sampling parameters to perform real-time object ranking and selection accurately and efficiently. As an example, rather than the online processing system having to analyze numerous candidate objects, the online processing system can select a pre-computed retrieval set and/or select objects from within the retrieval set, thereby relying on the analysis of the offline processing system without the need for expending significant amounts of additional processing resources. Moreover, to select a retrieval set and/or objects within the retrieval set, the online processing system can perform online sampling initialized with the sampling parameters learned by the offline processing system, rather than the online processing system having to learn the sampling parameters independently, which is compute intensive and time consuming. By doing so, the online processing system can respond to requests received from user devices or other systems with high-quality data, thereby minimizing response messages that contain irrelevant data or otherwise do not satisfy the demands of the user devices, the online processing system, or other systems, and thereby reducing the volume of additional request messages and response messages that are communicated. This also may reduce how much the online processing system may need to direct or prompt the user device to send additional requests in order for the user device to meet the expectations of the online processing system for receiving selections from the user device. In this way, significant processing resources, power resources, and network resources are conserved. This enables the online processing system to process requests from a much larger number of user devices or other systems and/or enables the online processing system to be implemented in less-complex devices, such as mobile devices or edge nodes, because powerful centralized computing resources are not needed to produce high-quality data online in real time.

Some implementations described herein relate to a system using distributed online and offline processing. The system may include one or more memories and one or more processors communicatively coupled to the one or more memories. The one or more processors may be configured to retrieve, from a data node, a dataset indicating a plurality of cloud service groups indicating a plurality of cloud infrastructure objects. The one or more processors may be configured to determine, using an offline processing system, first sampling parameters for cloud service groups, second sampling parameters for cloud infrastructure objects, and a plurality of retrieval sets for the plurality of cloud service groups using offline sampling that is based on multiple-metric efficacy values, where the multiple-metric efficacy values are based on one or more efficacy metrics and one or more policy metrics. The one or more processors may be configured to transmit, from the offline processing system and to an online processing system, the first sampling parameters, the second sampling parameters, and the plurality of retrieval sets. The one or more processors may be configured to determine, using the online processing system, a selected cloud service group, of the plurality of cloud service groups, by performing online sampling based on the first sampling parameters. The one or more processors may be configured to determine, using the online processing system, a cloud infrastructure object ranking in a retrieval set for the selected cloud service group by performing online sampling based on the second sampling parameters. The one or more processors may be configured to generate, based on the cloud infrastructure object ranking, a cloud computing configuration deployable for the selected cloud service group.

Some implementations described herein relate to a method using distributed online and offline processing. The method may include receiving, by an online processing component of a system and from an offline processing component of the system, a plurality of retrieval sets that are based on offline sampling that uses multiple-metric efficacy values that are based on one or more efficacy metrics and one or more policy metrics, where the plurality of retrieval sets are from a plurality of clusters of a set of object embeddings representative of a plurality of objects. The method may include receiving, by the online processing component, information regarding a user device in connection with a request from the user device. The method may include selecting, by the online processing component and based on the information regarding the user device, a retrieval set of the plurality of retrieval sets. The method may include generating, by the online processing component and based on selecting the retrieval set, code or markup for a user interface of the user device based on the request.

Some implementations described herein relate to an apparatus. The apparatus may include means for receiving a plurality of retrieval sets, first sampling parameters, and second sampling parameters that are based on offline sampling that uses multiple-metric efficacy values that are based on one or more efficacy metrics and one or more policy metrics, where the plurality of retrieval sets are from a plurality of clusters of a set of object embeddings representative of a plurality of objects. The apparatus may include means for selecting a retrieval set of the plurality of retrieval sets by performing online sampling using the first sampling parameters. The apparatus may include means for determining an object ranking in the retrieval set by performing online sampling using the second sampling parameters. The apparatus may include means for generating code or markup based on the object ranking in the retrieval set.

### BRIEF DESCRIPTION OF THE DRAWINGS

FIGS. 1A-1D illustrate an example environment associated with distributed online and offline processing.

FIG. 2A illustrates an example of embedding generation.

FIG. 2B illustrates an example of distributed online and offline processing.

FIG. 3 is a diagram of example components of a device associated with distributed online and offline processing.

FIG. 4 is a flowchart of an example process associated with distributed online and offline processing.

### DETAILED DESCRIPTION

The following detailed description of example implementations refers to the accompanying drawings. The same reference numbers in different drawings may identify the same or similar elements.

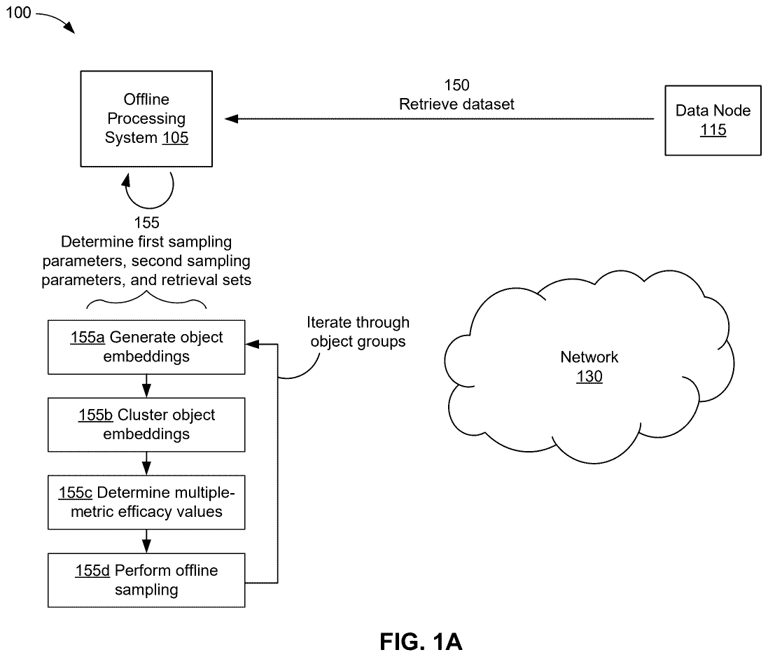

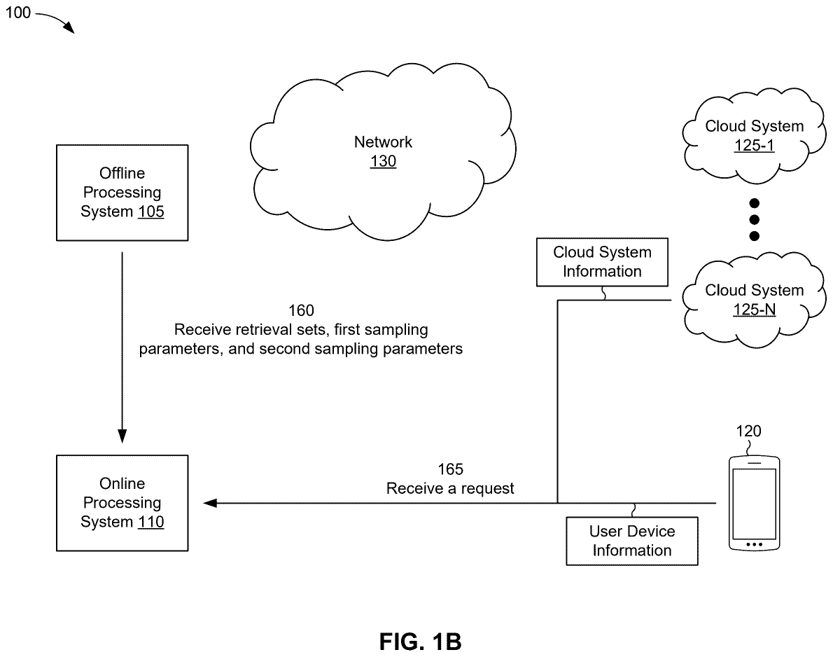

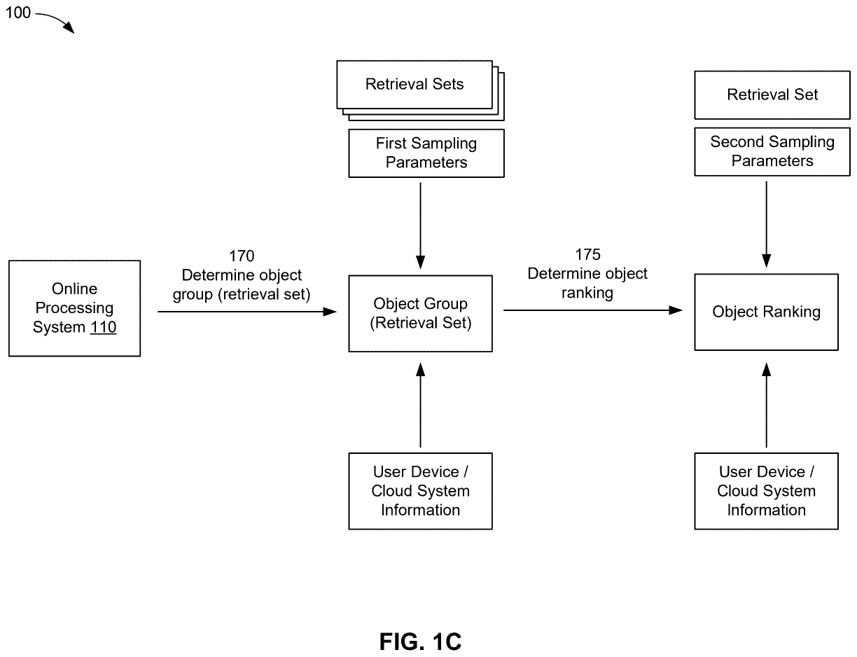

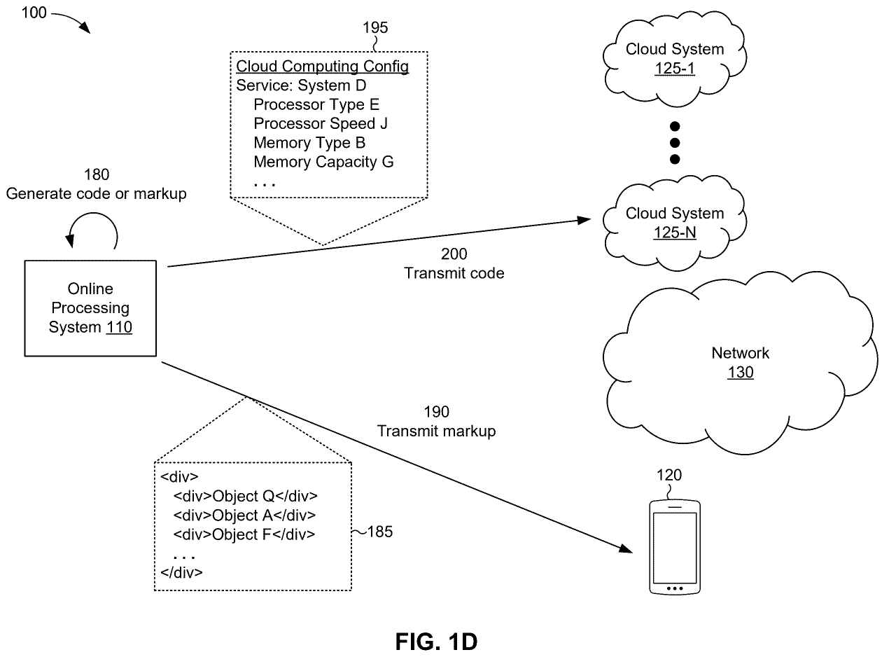

FIGS. 1A-1D illustrate an example environment 100 associated with distributed online and offline processing. As shown, the environment 100 includes an offline processing system 105, an online processing system 110, a data node 115, a user device 120, cloud systems 125-1 through 125-N (referred to individually as a cloud system 125), and a network 130.

Communication among the devices and systems of environment 100 may be performed via the network 130. The network 130 may include one or more wired and/or wireless networks. For example, the network 130 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks.

A cloud system 125 may implement a suite of on-demand computing resources and services designed to support a wide range of applications and workloads. For example, the cloud system 125 may facilitate the building, deployment, and management of applications without the need for physical infrastructure. The cloud system 125 may provide cloud-based processing, storage, and/or databases, among other examples, implemented through a geographically-distributed network of data centers. For example, the cloud system 125 may provide scalable computing resources, scalable storage resources, and/or database management services, among other examples. As an example, the cloud system 125 enables creation and management of virtual servers, serverless compute instances, virtual storage, virtual networking infrastructure, networking configurations, virtual load balancers, container environments, or the like. In some implementations, a plurality of cloud systems 125-1 through 125-N (e.g., including at least a first cloud system and a second cloud system) may be controlled by respective entities, and therefore distinct from one another in terms infrastructure or service offerings.

The data node 115 may include storage, one or more data sources, one or more data services (e.g., accessible via an application programming interface (API)), and/or one or more databases, among other examples. The data node 115 stores information relating to a plurality of object groups and information relating to objects within each object group. An “object group” may refer to a collection of objects that share common characteristics, a common theme, or a common category. An object group may be identified by a label (e.g., a name, an identifier, or the like) that distinctly refers to the object group.

In some implementations, the object groups may include collections of virtual objects (e.g., cloud infrastructure objects, cryptography token objects, or the like). For example, the object groups may be cloud service groups that include respective collections of cloud infrastructure objects. Each cloud service group may relate to a respective cloud system (e.g., that provides a collection of cloud services) or a respective cloud service (e.g., a compute service, a storage service, a database service, a networking service, an application service, or the like) of one or more cloud systems. For example, a first cloud service group may include cloud infrastructure objects associated with (e.g., deployable or configurable in) cloud system 125-1, a second cloud service group may include cloud infrastructure objects associated with cloud system 125-N, and so forth. As another example, a first cloud service group may include cloud infrastructure objects associated with a first cloud service (e.g., a compute service), a second cloud service group may include cloud infrastructure objects associated with a second cloud service (e.g., a database service), and so forth.

A “cloud infrastructure object” may refer to a parameter, a setting, or a class configurable or deployable for a resource or a service offered in a cloud system. For example, a cloud infrastructure object may relate to a processor resource, a memory resource, a storage resource, a networking resource, a database service, a security service, a redundancy service, a backup and recovery service, and/or an application service, among other examples, implemented in a cloud system. In particular, a cloud infrastructure object may relate to a processor resource type, a processor resource speed, a quantity of processor resources, a memory resource type, a memory resource size, a quantity of memory resources, a storage resource type, a storage resource capacity, a bandwidth allocation, a load balancer resource type, a load balancer resource setting, a firewall resource type, a firewall resource setting, a database service setting, a security service setting, a backup service setting, a recovery service setting, or an application service setting, among other examples.

In some implementations, the object groups may include respective collections of physical objects (e.g., vehicles, sporting equipment, clothing items, or other items) or digital media objects (e.g., video media, image media, audio media, gaming media, or the like). For example, a first object group may include video media objects associated with a comedy genre, a second object group may include video media objects associated with a drama genre, and so forth.

The data node 115 may additionally store historical data relating to objects. For example, the historical data may relate to uses, interactions, or activities associated with the objects. As an example, for cloud infrastructure objects, the historical data may relate to historical deployments of cloud infrastructure objects, historical uses of cloud infrastructure objects, historical errors relating to cloud infrastructure objects, or the like. As another example, for digital media objects, the historical data may relate to access events for digital media objects, play counts for digital media objects, ratings given to digital media objects, or the like. As a further example, for objects (e.g., physical objects) represented by elements in a user interface (e.g., of a web browser or a dedicated application), the historical data may relate to selections of (e.g., clicks on, click-through rates (CTRs) for) the elements, interactions with software component(s) that track subset(s) of (e.g., add to cart events for) the objects, or the like.

The data node 115 may provide any of the aforementioned information to the offline processing system 105 and/or to the online processing system 110 (e.g., via the network 130). In some implementations, communications of the data node 115 with the offline processing system 105 and/or the online processing system 110 may be performed locally (e.g., within a cloud computing environment) rather than through the network 130.

The user device 120 may include a communication device and/or a computing device. For example, the user device 120 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 120 may implement a user interface facilitating user-computer interaction and communication, and may include display screens, keyboards, a mouse, and the appearance of a desktop. For example, a user interface may include a way a user interacts with an application or a website. The user device 120 may exchange data with the online processing system 110. For example, data exchanged with the online processing system 110 may be in connection with the user device 120 accessing a web page using a web browser installed on the user device 120.

The offline processing system 105 may include a communication device and/or a computing device. For example, the offline processing system 105 may include one or more physical servers, one or more virtual servers (e.g., executing on computing hardware), and/or cloud computing resources (e.g., executing on computing hardware used in a cloud computing environment). “Offline processing” may refer to the execution of data processing tasks independently from real-time user inputs.

In some implementations, communications between the offline processing system 105 and the online processing system 110 may be performed through the network 130. For example, the offline processing system 105 may be a centralized processing system located on dedicated server(s) or cloud computing environment(s) that have a significant amount of computing resources, to perform the actions described below, that are not available or at least cannot be routinely utilized by the online processing system 110 in the same way. The offline processing system 105 may communicate with and perform the same role for multiple online processing systems 110 that may be distributed in different geographic areas and/or communicate with different groups of user devices 120. In this way, the offline processing system 105 may reduce the processing resources that are utilized compared to, for example, each online processing system 110 having to have the same actions performed by a dedicated offline processing system.

In other implementations, communications between the offline processing system 105 and the online processing system 110 may be performed locally (e.g., within a cloud computing environment) rather than through the network 130. For example, the offline processing system 105 and the online processing system 110 may be implemented in the same cloud computing resource or in separate cloud computing resources within the same cloud computing environment. In some implementations, the offline processing system 105 and the online processing system 110 may be components (e.g., co-located components or distributed components) of the same higher-level processing system. For example, the offline processing system 105 and the online processing system 110 may be hardware components or software components of the same system.

The online processing system 110 may include a communication device and/or a computing device. For example, the online processing system may include one or more physical servers, one or more virtual servers (e.g., executing on computing hardware), and/or cloud computing resources (e.g., executing on computing hardware used in a cloud computing environment). In some implementations, the online processing system 110 may be implemented on an edge node of a network or of a cloud system (e.g., in a regional data center of the cloud system). In some implementations, the online processing system 110 may be a component (e.g., a hardware component or a software component) of the user device 120. “Online processing” may refer to the execution of data processing tasks in response to real-time user inputs. For example, the online processing system 110 may include a serving system or layer.

As shown in FIG. 1A, and by reference number 150, the offline processing system 105 may retrieve, from the data node 115, a dataset indicating a plurality of objects groups that each include a respective plurality of objects. For example, a first object group (e.g., for cloud system 125-1) may include a first plurality of objects (e.g., “2 CPU, 1 GB memory instance,” “2 CPU, 8 GB memory instance,” “8 CPU, 64 GB memory instance,” etc.), and a second object group (e.g., for cloud system 125-N) may include a second plurality of objects (e.g., “1 CPU, 3.75 GB memory instance,” “4 CPU, 4 GB memory instance,” “40 CPU, 961 GB memory instance,” etc.). The offline processing system 105 may also retrieve the historical data relating to the object groups.

As shown by reference number 155, the offline processing system 105 may determine first sampling parameters for object groups, second sampling parameters for objects, and/or a plurality of retrieval sets for the plurality of object groups, which will later be used in online processing. “Sampling parameters” may refer to values derived from offline sampling that are used to guide the selection process in online sampling. Thus, the sampling parameters, derived from prior data analysis, enable efficient online sampling. A “retrieval set” may refer to a subset of objects from an object group that enables online processing to be performed using less and simpler data.

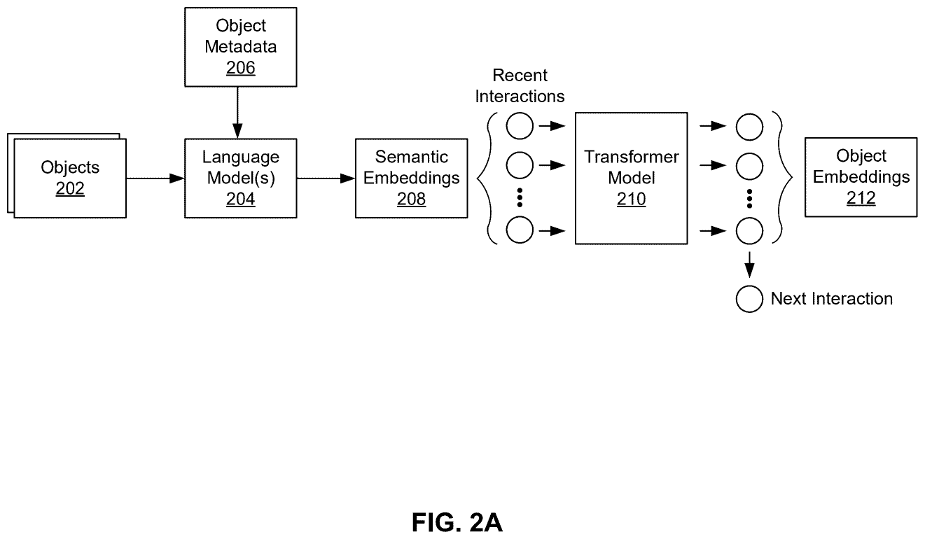

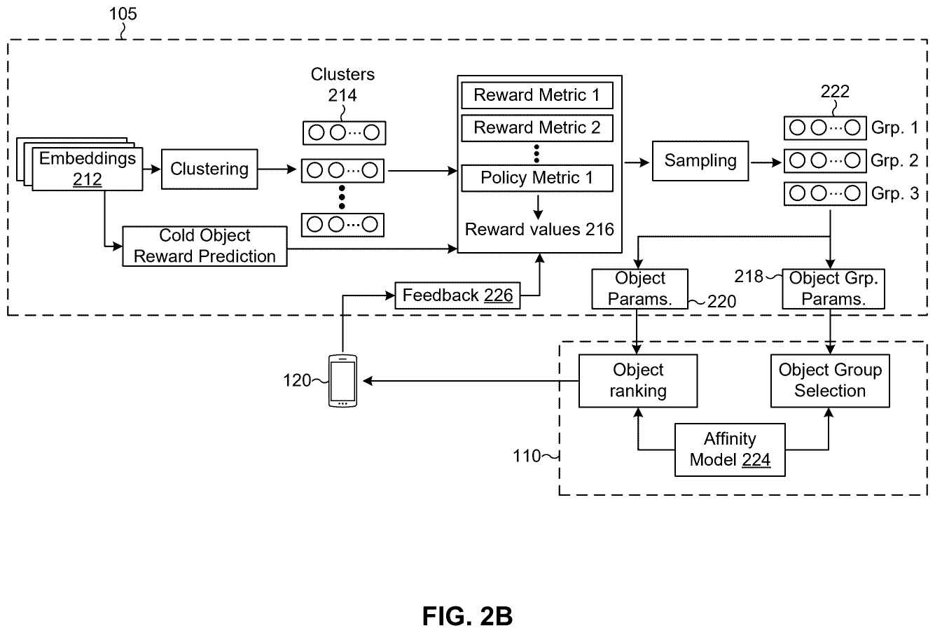

The offline processing system 105 may determine the first sampling parameters, the second sampling parameters, and/or the retrieval sets by iteratively processing each of the object groups. For example, for each object group, the offline processing system 105 may generate a set of object embeddings representative of a plurality of objects in the object group (as shown by reference number 155a), cluster the set of object embeddings to obtain a plurality of clusters (as shown by reference number 155b), determine a plurality of multiple-metric efficacy values (e.g., that include one or more policy metrics that reflect preferences for one or more policies) from the historical data (as shown by reference number 155c), and perform offline sampling (e.g., offline Thompson sampling) of the clusters based on the multiple-metric efficacy values to obtain a retrieval set (e.g., containing one or more objects from each of the clusters) and derive sampling parameters (as shown by reference number 155d). These steps are described in greater detail in connection with FIGS. 2A-2B. The sampling parameters represent learned parameters for the objects derived from the offline sampling. For example, the sampling parameters for an object may represent a prior distribution to be used for initiating online sampling. In this way, the offline processing allows for extensive processing without the constraints of real-time performance, thereby enabling lightweight models and efficient computational tasks to be performed during online processing.

The efficacy values may be based on a combination of multiple metrics. For example, each efficacy value may represent a combination of one or more efficacy metrics (e.g., reward metrics) and/or one or more policy metrics, as described above and further below. An “efficacy metric” may refer to a quantitative measure used to evaluate the success or utility of an object (e.g., number of uses, play count, rating, click-through rate, etc.). As an example, for cloud infrastructure objects, the efficacy metrics may relate to a number of times that a cloud infrastructure object has been used, a number of hours that a cloud infrastructure object has been deployed, a number of errors detected in connection with use of a cloud infrastructure object, or the like. As another example, for digital media objects, the efficacy metrics may relate to a play count for a digital media object, a rating given to a digital media object, or the like. As a further example, for items (e.g., physical objects described in electronic documents, such as web pages), the efficacy metrics may include engagement metrics, such as number of clicks, click-through rate, number of add-to-cart events, add-to-cart rate, or the like.

A “policy metric” may refer to a quantitative measure used to express a policy preference. For example, a policy preference may indicate a policy to promote favored objects possessing particular characteristics over unfavored objects lacking those characteristics (e.g., promote cloud database services over cloud compute services, promote high resolution videos over low resolution videos, or promote sports equipment over groceries). A policy metric may reflect such a policy using a set of weightings applied to respective types of objects. For example, higher weightings may be assigned to more favored objects according to how favored they are, and lower weightings may be assigned to less favored objects according to how favored they are. For example, the policy metric may use a higher value (e.g., 0.8) for favored objects, and a lower value (e.g., 0.2) for unfavored objects. As examples, policy metrics may indicate relative weightings for a click metric (e.g., click-through rate) and a cart metric (e.g., add-to-cart rate), or relative weightings for a first type of object (e.g., sports equipment) and a second type of object (e.g., groceries). As another example, a policy metric may reflect a policy to promote a particular pool of objects (e.g., high-cost objects or low-cost objects). A policy metric may reflect such a policy by increasing an efficacy value by a particular amount for objects in the pool being promoted but not for objects outside of the pool being promoted. In this way, the policy metrics my bias the efficacy values, thereby artificially enhancing the relevance of objects that best reflect the underlying policies.

To determine an efficacy value for an object, the offline processing system 105 may combine the values for each efficacy metric and each policy metric using a linear function (e.g., that provides weightings to each efficacy metric and each policy metric) to compute the overall efficacy value. For example, an efficacy value may be a weighted sum of one or more efficacy metrics and one or more policy metrics. The use of policy metrics in the efficacy values enables steering of the sampling toward objects that otherwise would not be selected by the sampling if only efficacy metrics are used. In this way, the policy metrics facilitate improved sampling results that surface relevant objects with improved efficiency. Accordingly, the policy metrics improve the quality of the data provided by the offline processing system 105 to the online processing system 110, thereby enabling the online processing system 110 to respond to requests more accurately and efficiently, thus reducing the resources consumed by repeated requests from user device 120 that may be required to satisfy one or more policies expressed by the policy metrics. The policy metrics also enable the online processing system 110 to reduce how much the online processing system 110 may need to direct or prompt the user device 120 to send additional requests and/or send follow-up responses in order to satisfy the one or more policies because the online processing system 110 responds to earlier requests more accurately and efficiently. This further reduces the resources consumed by the online processing system 110 and the user device 120 to achieve the preferred outcomes embodied in the one or more policies.

As shown in FIG. 1B, and by reference number 160, the online processing system 110 may receive the first sampling parameters, the second sampling parameters, and/or the retrieval sets from the offline processing system 105 (e.g., via the network 130), thereby providing the online processing system 110 with pre-generated data that reduces the amount of processing needed at the online processing system 110. For example, rather than the online processing system 110 having to analyze numerous candidate objects, the online processing system 110 can select a pre-computed retrieval set and/or select objects from within the retrieval set, thereby expending significantly less processing resources to identify relevant objects. Moreover, the online processing system 110 can perform online sampling initialized with the sampling parameters learned by the offline processing system 105, rather than the online processing system 110 having to learn the sampling parameters independently, which is compute intensive and time consuming. By doing so, the online processing system 110 can respond to requests received from the user device 120 or a cloud system 125 with relevant, high-quality data despite having relatively limited processing power, thereby minimizing repetitive requests and responses that would otherwise result from response messages that contain irrelevant data or data that otherwise does not satisfy the demands of the user device 120, the cloud system 125, and/or online processing system 110.

Thereafter, as shown by reference number 165, the online processing system 110 may receive a request (e.g., a request message) from the user device 120 or the cloud system 125. For example, the user device 120 may request a resource (e.g., a web page) from the online processing system 110. In some implementations, the request may be an HTTP request. The resource being requested by the user device 120 may contain data generated by the online processing system 110.

In connection with the request from the user device 120 or the cloud system 125, the online processing system 110 may receive information regarding the user device 120 or the cloud system 125 (e.g., the request may include the information). In some examples, the online processing system 110 may obtain the information when the user device 120 accesses the requested resource. The information regarding the user device 120 may indicate a technical platform of the user device 120, such as information indicating a hardware model number or generation of the user device 120, a display size of the user device 120, a display resolution of the user device 120, a processor type of the user device 120, an operating system of the user device 120, and/or an application used by the user device 120 to transmit the request (e.g., a dedicated mobile application that is for a particular type of mobile operating system and is configured to specifically interact with online processing system 110, a mobile web browser, a desktop web browser, etc.), among other examples. In some examples, the information regarding the user device 120 may indicate interactions of the user device 120 (e.g., interactions with user-interface elements of the online processing system 110, resources accessed in the online processing system 110, or the like). The information regarding the cloud system 125 may indicate a technical platform of the cloud system 125, such as capabilities or statuses (e.g., active or inactive) relating to computing services of the cloud system 125, storage services of the cloud system 125, database services of the cloud system 125, or networking services of the cloud system 125, among other examples.

As shown by reference number 170, in response to receiving the request, and based on the first sampling parameters, the online processing system 110 may determine an object group (e.g., that is most likely to be relevant) using online sampling (e.g., online Thompson sampling). For example, the online processing system 110 may select a retrieval set, associated with the object group, from the plurality of retrieval sets. Additionally, or alternatively, as shown by reference number 175, in response to receiving the request, and based on the second sampling parameters, the online processing system 110 may determine an object ranking (e.g., in an order of relevance) of the objects in the retrieval set of the determined object group using online sampling (e.g., online Thompson sampling). For example, the online processing system 110 may rank the objects in the second object group (e.g., #1: “40 CPU, 961 GB memory instance” . . . #21: “4 CPU, 4 GB memory instance” . . . #142: “1 CPU, 3.75 GB memory instance,” etc.). In some implementations, the online processing system 110 may select a top K (e.g., 5, 10, 15, or 20) of the ranked objects for subsequent use.

In some implementations, the online processing system 110 may determine the object group and/or the object ranking additionally, or alternatively, based on the information regarding the user device 120 and/or the cloud system 125. The information regarding the user device 120 may include, for example, whether the user device 120 used a first type of mobile application for a first type of mobile operating system, a second type of mobile application for a second type of mobile operating system, a first type of mobile browser for the first type of mobile operating system, a second type of mobile browser for a second type of mobile operating system to generate the request, and/or a particular type of browser for a desktop computer. For example, different object groups may contain objects relevant to, or suitable for, different technical platforms and/or different interaction histories. As an example, if the user device 120 is using the first type of mobile application, then the online processing system 110 may select an object group and/or rank objects based on relevance to the first type of mobile application (e.g., displaying information regarding the objects in the first type of mobile application, historical selections of objects using the first type of mobile application relative to using a different type of mobile application or a particular browser, etc.). Continuing with the example, the online processing system 110 may select a different object group and/or rank objects differently for the second type of mobile application. In some implementations, the offline processing system 105 may provide different retrieval sets for object groups relevant to different technical platforms, which enables selection by the online processing system 110 based on the information regarding the user device 120 or the cloud system 125 without the offline processing system 105 needing to receive such information. For example, the offline processing system 105 may provide one or more first retrieval sets for the first type of mobile application, one or more second retrieval sets for the second type of mobile application, one or more third retrieval sets for the first type of mobile browser, one or more fourth retrieval sets for the first type of mobile browser, and/or one or more fifth retrieval sets for the second type of mobile browser, etc.

In some implementations, the online processing system 110 may determine the object group and/or the object ranking using the online sampling and one or more affinity models (e.g., that provide outputs based at least in part on the information regarding the user device 120). An “affinity model” may refer to a predictive model trained to predict a preference or a behavior through historical data (e.g., historical interactions on the user device 120 (or other user devices) with a user interface corresponding to, or provided by, the online processing system 110). In some implementations, the online processing system 110 may determine, using an affinity model, an affinity output relating to the object groups (e.g., a prediction or ranking of object groups relevant to a user). Thus, the online processing system 110 may determine the object group (e.g., select the retrieval set) using online sampling based on the first sampling parameters 218 and using the affinity output. For example, the online processing system 110 may select the object group based on a combined result (e.g., using weightings) of the online sampling and the affinity output.

In some implementations, the online processing system 110 may determine, using an affinity model, an affinity output relating to objects in the retrieval set 222 for the selected object group (e.g., a prediction or ranking of objects relevant to a user). Thus, the online processing system 110 may determine the object ranking using online sampling based on the second sampling parameters 220 and using the affinity output. For example, the online processing system 110 may rank objects based on a combined result (e.g., using weightings) of the online sampling and the affinity output.

In some implementations, as shown in FIG. 1D, and by reference number 180, the online processing system 110 may use the object ranking to generate code (e.g., infrastructure code, JSON, or the like) and/or markup (e.g., HTML or XML). For example, the online processing system 110 may generate markup 185 for a web page, and the markup 185 may configure content relating to one or more objects in accordance with the object ranking (e.g., the markup 185 may configure the content to display a list of objects in the order of the object ranking). For example, the markup 185 may configure display of a first object in the object ranking (e.g., a first digital media object), followed by a second object in the object ranking (e.g., a second digital media object), and so forth. In addition, as shown by reference number 190, the online processing system 110 may transmit the markup 185 for the web page to the user device 120 (e.g., in an HTTP response).

As described further below with reference to FIG. 2B, the user device 120 may provide, for display, a user interface in a web browser or a dedicated application that includes the content relating to the one or more objects based on the code and/or markup. Based on that, the user device 120 may identify selections of one or more objects, from the list of objects, in the user interface and/or generate additional requests for additional content relating to different objects. The user device 120 may transmit information regarding the selections and/or the additional requests to the online processing system 110. The user device 120 may also generate feedback information based on the selections, the requests, and/or other information (e.g., information regarding other types of interactions with the content, events based on the selections, etc.). The user device 120 may transmit the feedback information (e.g., via the online processing system 110 or in another manner) to the offline processing system 105.

The online processing system 110, based on the selections and/or the additional requests and based on the retrieval sets and the sampling parameters previously provided by the offline processing system 105, may generate additional responses that include code and/or markup that configure content relating to one or more additional objects. The online processing system 110 may transmit the additional responses to the user device 120. This process may repeat until the preferred outcomes, embodied in the one or more policies, are satisfied.

However, the total amount of additional requests and additional responses that are required to satisfy the preferred outcomes may be reduced because the offline processing system 105 took into account the one or more policies to determine the retrieval sets and the sampling parameters, which in turn reduces the processing and networking resources that will need to be consumed the user device 120 and the online processing system 110 to handle the additional requests and the additional responses.

The offline processing system 105 may adjust, based on the feedback information, how new retrieval sets and sampling parameters are generated to better satisfy the preferred outcomes embodied in the one or more policies. This may improve the quality of the new retrieval sets and sampling parameters that are provided by the offline processing system 105 to the online processing system 110, which in turn further reduces the processing and networking resources that will need to be consumed the user device 120 and the online processing system 110 by further reducing the amount of additional requests and/or additional responses needed to satisfy the preferred outcomes.

In one example, the online processing system 110 may use cloud infrastructure object rankings and/or information regarding selections of one or more cloud infrastructure objects to generate a cloud computing or infrastructure configuration 195 deployable in the selected cloud service group (e.g., in cloud system 125-N). For example, the online processing system 110 may generate infrastructure code representing the configuration 195 that uses the one or more cloud infrastructure objects in accordance with the cloud infrastructure object rankings. For example, the configuration 195 may use the top K (e.g., 5, 10, 15, or 20) ranked objects in the cloud infrastructure object ranking, or may use the top ranked objects across multiple infrastructure categories (e.g., the top ranked compute instance, the top ranked storage resource, the top ranked database configuration, etc.). Moreover, as shown by reference number 200, the online processing system 110 may transmit the configuration 195 (e.g., the code) to a cloud system (e.g., cloud system 125-N) for deployment in accordance with the configuration 195.

As indicated above, FIGS. 1A-1D are provided as an example. Other examples may differ from what is described with regard to FIGS. 1A-1D.

FIG. 2A illustrates an example of embedding generation. Techniques described herein may use object embeddings 212 to promote diversity in object rankings as well as to provide a warm start for cold objects (e.g., objects associated with little or no historical data). The operations of FIG. 2A may be performed by the offline processing system 105.

As shown in FIG. 2A, the offline processing system 105 may generate object embeddings 212 representative of the objects 202 in a plurality of object groups. To begin, the offline processing system 105, using one or more language models 204, may generate semantic embeddings 208 based on object metadata 206. The object metadata 206 may indicate characteristics, properties, and/or parameters associated with the objects 202. For example, for cloud infrastructure objects, the object metadata 206 may indicate a cloud service type (e.g., compute service, storage service, database service, etc.), an object type (e.g., processor, memory, virtual CPU, storage, database, etc.), a speed value, a capacity value, a quantity, or the like. The semantic embeddings 208 are vector representations of the metadata 206 that capture the meaning and context of the values, words, or phrases in the metadata 206. For example, the semantic embeddings 208 map words or phrases in the metadata 206 to high-dimensional vectors, where the proximity between vectors indicates semantic similarity. By using numerical representations rather than textual data, the offline processing system 105 can process the metadata 206 more efficiently and effectively.

The offline processing system 105, using a transformer model 210, may generate the object embeddings 212 based on the semantic embeddings 208. The object embeddings 212 may add information about the relatedness between objects 202 to the semantic embeddings 208. In particular, the transformer model 210 may be trained to predict the next event (e.g., next interaction) in a sequence based on past events (e.g., recent interactions). Thus, the transformer model 210 may be trained to perform sequential recommendation. However, rather than using the next event prediction, the object embeddings 212 are based on the last layer embeddings of the transformer model 210. These last layer embeddings provide a contextualized representation of the input text. In this way, the object embeddings 212 improve the ability of the offline processing system 105 to identify retrieval sets of relevant objects and sampling parameters used for object ranking, which can be indicated to the online processing system 110. Thus, the online processing system 110 is able to produce high-quality data in response to requests using its limited processing power, thereby reducing repetitive request and response cycles.

As indicated above, FIG. 2A is provided as an example. Other examples may differ from what is described with regard to FIG. 2A.

FIG. 2B illustrates an example of distributed online and offline processing. As shown, the offline processing system 105 may perform a series of operations iteratively for each of a plurality of object groups. In some examples, the object embeddings 212 may be generated for all of the object groups prior to this iterative processing. In some other examples, the object embeddings 212 for an object group may be generated as part of a processing iteration for that object group.

In a processing iteration for an object group, the offline processing system 105 may first cluster the object embeddings 212, that represent the objects in the object group, to obtain a plurality of clusters 214. In other words, the plurality of clusters 214 relate to objects in the object group. The clustering may involve grouping similar object embeddings 212 together based on their vector representations in a continuous space, which helps in identifying relationships in the objects. The clustering can be performed using various clustering algorithms, such as K-means, which partitions the embeddings into K clusters by minimizing the variance within each cluster, or (density-based spatial clustering of applications with noise (DBSCAN), which groups embeddings based on density and can identify clusters of varying shapes and sizes. Another example is hierarchical clustering, which builds a tree of clusters by iteratively merging or splitting existing clusters based on a chosen distance metric.

In the same processing iteration, the offline processing system 105 may then determine a plurality of efficacy values 216 relating to the objects in the object group (e.g., based on historical data). Each efficacy value 216 may be a combination of multiple metrics. For example, each efficacy value 216 may represent a combination of one or more efficacy metrics (e.g., reward metrics) and/or one or more policy metrics, as described above.

In some examples, the objects may include one or more cold objects and one or more warm objects, where the cold objects are associated with less historical data than the warm objects. The use of the object embeddings 212 also enables prediction of efficacy values 216 for these cold objects. For example, the offline processing system 105 may determine an efficacy value 216 for a cold object based on a similarity of an object embedding 212 for the cold object to an object embedding 212 of a warm object (e.g., according to the clusters 214).

In the same processing iteration, the offline processing system 105 may then perform offline sampling (e.g., using a sampling model) of the plurality of clusters 214 based on the efficacy values 216 to identify the first sampling parameters 218 for object groups, the second sampling parameters 220 for objects, and/or the retrieval set 222 for the object group. “Offline sampling” may refer to sampling that uses historical data to simulate actions as if they were taken in an online setting. In some examples, the offline sampling is offline Thompson sampling. In other examples, a different type of exploration-exploitation sampling may be used, such as sampling using a greedy algorithm, an upper confidence bound (UCB), Bayesian optimization, or the like.

The offline Thompson sampling may be performed using the historical data. Each data point in the historical data may indicate an action taken (e.g., deploying a cloud infrastructure object or recommending a digital media object) and its associated efficacy metrics (e.g., rewards), which are used to compute an efficacy value 216 for the action, as described herein. The offline Thompson sampling may begin by initializing a prior distribution for each action. For each action, a value is sampled from the posterior distribution, which is updated after each trial. Next, the action corresponding to the highest sampled value is selected. After each trial, the posterior distribution of the chosen action is updated using the computed efficacy value 216, and the parameters are adjusted based on the outcome. This process continues iteratively, with each action's probability distribution being refined. Sampling parameters for an object group may be identified in this manner using averaged data relating to the objects within that object group.

Using offline Thompson sampling on the efficacy values 216, the offline processing system 105 may select the top K objects from each cluster 214. The retrieval set 222 for the object group may therefore include the objects selected from each cluster 214. Moreover, the offline processing system 105 may use the iterative process of the offline Thompson sampling to obtain the first sampling parameters 218 for the object group and the second sampling parameters 220 for the objects (e.g., the updated posterior distributions). For example, sampling parameters may be used as a prior distribution for initializing online sampling, thereby reducing the processing resources needed by the online processing system 110 to select relevant objects groups and rank objects.

Upon completion of this processing iteration, the offline processing system 105 may move to the next object group and perform an additional processing iteration for the next object group in a similar manner as described herein. As a result of the additional processing iteration, the offline processing system 105 may obtain a retrieval set 222 for the next object group, first sampling parameters 218 for the next object group, and second sampling parameters 220 for objects in the next object group. Thus, by iterating through all object groups, the offline processing system 105 will obtain retrieval sets 222 for each object group, first sampling parameters 218 for each object group, and second sampling parameters 220 for the objects across each object group.

As shown, the offline processing system 105 may transmit the first sampling parameters 218, the second sampling parameters 220, and/or the retrieval sets 222 to the online processing system 110. In some examples, this transmission may include the offline processing system 105 storing the first sampling parameters 218, the second sampling parameters 220, and/or the retrieval sets 222 in a cache, and the online processing system 110 retrieving them from the cache.

The online processing system 110 may use the first sampling parameters 218, the second sampling parameters 220, and/or the retrieval sets 222 to handle new, real-time requests and/or make new, real-time recommendations. For example, in response to a request (e.g., from the user device 120), the online processing system 110 may determine (e.g., select) an object group (e.g., a retrieval set) based on the first sampling parameters 218. In particular, the online processing system 110 may perform online sampling (e.g., online Thompson sampling) of the object groups, in a similar manner as described above, using the first sampling parameters 218 to initialize the online sampling (e.g., the online sampling model). In addition, the online processing system 110 may determine an object ranking in the retrieval set 222 for the selected object group (e.g., rather than for all objects in the selected object group) based on the second sampling parameters 220. In particular, the online processing system 110 may perform online sampling (e.g., online Thompson sampling) of the objects in the retrieval set 222, in a similar manner as described above, using the second sampling parameters 220 to initialize the online sampling (e.g., the online sampling model).

In some implementations, the online processing system 110 may determine the object group and/or the object ranking using information regarding the user device 120, as described herein. In some implementations, the online processing system 110 may determine the object group and/or the object ranking using the online sampling and one or more affinity models 224 (e.g., that provide outputs based at least in part on the information regarding the user device 120), as described here.

As shown, in response to a request, the online processing system 110 may transmit information (e.g., code or markup, as described herein) indicating one or more objects in accordance with the object rankings (e.g., the one or more objects may be one or more top ranked objects) to the user device 120. Additionally, or alternatively, the online processing system 110 may transmit information (e.g., infrastructure code, as described herein) indicating one or more cloud infrastructure objects in accordance with cloud infrastructure object rankings to a cloud system 125 for deployment of cloud infrastructure. By using the retrieval sets 222 and/or the sampling parameters 218, 220 received from the offline processing system 105, the online processing system 110 may provide relevant and high-quality data in response to a request despite having relatively limited processing power. In this way, the online processing system 110 conserves processing resources and network resources that otherwise would be expended by repeated requests and responses that would result from providing low-quality data that fails to meet the demands of the user device 120 or the cloud system 125.

In some implementations, the user device 120 or the cloud system 125 may provide feedback 226 relating to the one or more objects to the offline processing system 105, and the offline sampling may be re-run by the offline processing system 105. In some implementations, the online processing system 110 may collect the feedback 226 from the user device 120 or the cloud system 125, and provide the feedback 226 to the offline processing system 105. In one example, the feedback 226 may include deployment data relating to deployment of one or more cloud infrastructure objects. In another example, the feedback 226 may relate to interactions by the user device 120 with the one or more objects (e.g., interactions with user interface elements representing the one or more objects) in the online processing system 110. For example, the interactions may include clicks on user interface elements representing the one or more objects, add to cart events relating to the one or more objects, or the like. Based on the feedback 226, the offline processing system 105 may update one or more efficacy metrics, and then regenerate retrieval sets 222 and/or sampling parameters 218, 220 using the operations described herein to more efficiently satisfy the preferred outcomes embodied in the one or more policies. Thus, the feedback 226 enables improvements to the accuracy and reliability of the retrieval sets 222 and/or the sampling parameters 218, 220 indicated to the online processing system 110, thereby enabling the online processing system 110 to produce high-quality data in response to requests despite its more limited processing power, thereby conserving processing resources and network resources by reducing repetitive request and response cycles at the online processing system 110.

As indicated above, FIG. 2B is provided as an example. Other examples may differ from what is described with regard to FIG. 2B.

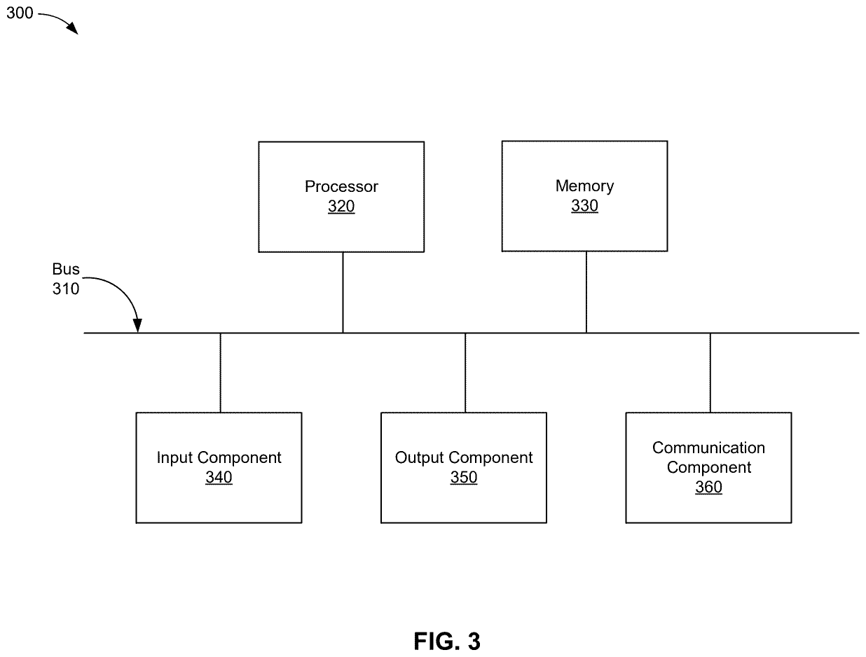

FIG. 3 is a diagram of example components of a device 300 associated with distributed online and offline processing. The device 300 may correspond to the offline processing system 105, online processing system 110, data node 115, user device 120, and/or a cloud system 125. In some implementations, offline processing system 105, online processing system 110, data node 115, user device 120, and/or a cloud system 125 may include one or more devices 300 and/or one or more components of the device 300. As shown in FIG. 3, the device 300 may include a bus 310, a processor 320, a memory 330, an input component 340, an output component 350, and/or a communication component 360. The bus 310, the processor 320, the memory 330, the input component 340, the output component 350, and/or the communication component 360 may provide means for performing one or more operations described herein.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

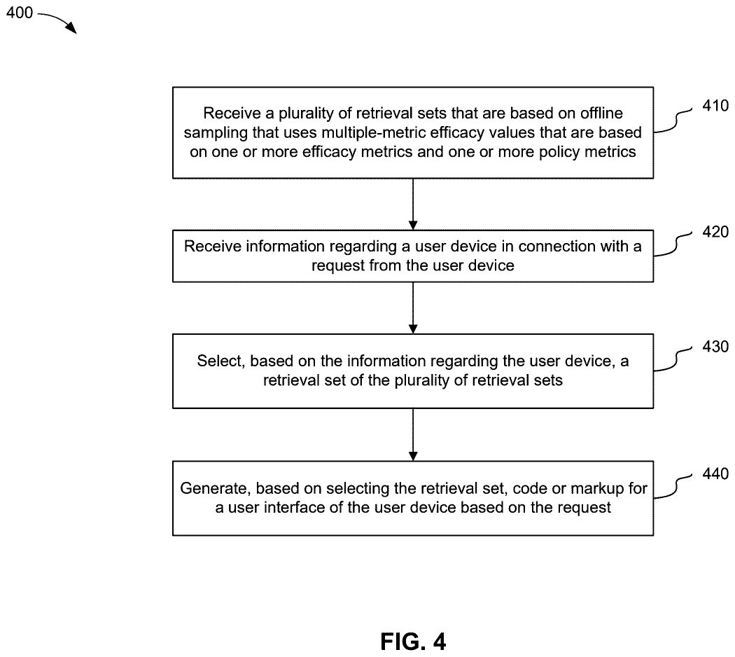

FIG. 4 is a flowchart of an example process 400 associated with distributed online and offline processing. For example, example process 400 may reduce processing resources, power resources, and network resources utilized by online processing systems and user devices to satisfy preferred outcomes, embodied in one or more policies, relating to interactions between online systems and user devices. In some implementations, one or more process blocks of FIG. 4 may be performed by a system. For example, the system may include an offline processing component (e.g., offline processing system 105) and an online processing component (e.g., online processing system 110). Additionally, or alternatively, one or more process blocks of FIG. 4 may be performed by one or more components of the device 300, such as processor 320, memory 330, input component 340, output component 350, and/or communication component 360.

At step 410, process 400 may include receiving a plurality of retrieval sets that are based on offline sampling that uses multiple-metric efficacy values that are based on one or more efficacy metrics and one or more policy metrics. For example, the system, by the online processing component and from the offline processing component, may receive a plurality of retrieval sets that are based on offline sampling that uses multiple-metric efficacy values that are based on one or more efficacy metrics and one or more policy metrics, as described herein. In some implementations, the plurality of retrieval sets are from a plurality of clusters of a set of object embeddings representative of a plurality of objects.

At step 420, process 400 may include receiving information regarding a user device in connection with a request from the user device. For example, the system, by the online processing component, receive information regarding a user device in connection with a request from the user device, as described herein. In some implementations, the request may be an HTTP request for a web page.

At step 430, process 400 may include selecting, based on the information regarding the user device, a retrieval set of the plurality of retrieval sets. For example, the system, by the online processing component and based on the information regarding the user device, may select a retrieval set of the plurality of retrieval sets, as described herein. In some implementations, the system may select the retrieval set (e.g., corresponding to a subset of an object group) by performing online Thompson sampling with the plurality of retrieval sets and/or using an affinity model based on the information regarding the user device.

At step 440, process 400 may include generating, based on selecting the retrieval set, code or markup for a user interface of the user device based on the request. For example, the system, by the online processing component and based on selecting the retrieval set, may generate code or markup for a user interface of the user device based on the request, as described herein. In some implementations, the system may rank the objects in the retrieval set by performing online Thompson sampling with the objects in the retrieval set and/or using an affinity model based on the information regarding the user device, and the code or markup may be based on the ranking of the objects in the retrieval set. In some implementations, the system may transmit the code or markup to the user device in an HTTP response.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

By utilizing retrieval sets and sampling parameters that are generated based on multiple-metric efficacy values that reflect one or more policy metrics, the online processing system 110 is able to provide much higher quality network content to help satisfy one or more preferred outcome embodied in the one or more policy metrics. The higher-quality content is of higher quality relative to lower-quality network content that the online processing system 110 would be able to generate on its own because the online processing system 110 would not be able to take into account the one or more policy metrics in the same way due to the limited available processing resources of the online processing system 110. Providing the higher-quality network content to the user device 120, relative to the lower-quality content, substantially reduces the amount of additional network content (e.g., network messages that includes additional requests and responses) that needs to be generated and transmitted between the online processing system 110 and the user device 120 to satisfy the preferred outcomes embodied in the one or more policies. The reduction in the amount of additional network content substantially reduces the processing, power, and networking resources that need to be utilized by the online processing system 110 and the user device 120 to satisfy the preferred outcomes.

The present techniques will be better understood with reference to the following enumerated aspects:
1. A method using distributed online and offline processing.
2. The method of aspect 1 comprising: receiving, by an online processing component of a system and from an offline processing component of the system, a plurality of retrieval sets that are based on offline sampling that uses multiple-metric efficacy values that are based on one or more efficacy metrics and one or more policy metrics, wherein the plurality of retrieval sets are from a plurality of clusters of a set of object embeddings representative of a plurality of objects;
receiving, by the online processing component, information regarding a user device in connection with a request from the user device; selecting, by the online processing component and based on the information regarding the user device, a retrieval set of the plurality of retrieval sets; and generating, by the online processing component and based on selecting the retrieval set, code or markup for a user interface of the user device based on the request.
3. The method of any of aspects 1-2, wherein receiving the plurality of retrieval sets comprises: receiving the plurality of retrieval sets, first sampling parameters, and second sampling parameters that are based on the offline sampling that uses the multiple-metric efficacy values.
4. The method of any of aspects 1-3, wherein selecting the retrieval set comprises: selecting the retrieval set based on the information regarding the user device and by performing online sampling using the first sampling parameters.
5. The method of any of aspects 1-4, further comprising: determining, by the online processing component, an object ranking in the retrieval set based on the information regarding the user device and by performing online sampling using the second sampling parameters.
6. The method of aspect 5, wherein determining the object ranking comprises: determining, using an affinity model and based on the information regarding the user device, an affinity output relating to objects in the retrieval set; and determining the object ranking by performing online sampling using the second sampling parameters, and using the affinity output.
7. The method of any of aspects 1-6, further comprising: generating, by the offline processing component, the set of object embeddings representative of the plurality of objects; clustering, by the offline processing component, the set of object embeddings to obtain the plurality of clusters; determining, by the offline processing component, the multiple-metric efficacy values based on data associated with the plurality of objects; and performing, by the offline processing component, offline sampling of the plurality of clusters based on the multiple-metric efficacy values to determine sampling parameters and the plurality of retrieval sets.
8. The method of any of aspects 1-7, wherein the one or more policy metrics indicate a set of weightings to be applied to respective types of objects.
9. The method of any of aspects 1-8, wherein generating the code or the markup comprises: generating the markup for a web page, wherein the method further comprises transmitting the markup for the web page to the user device.
10. The method of any of aspects 1-8, wherein generating the code or the markup comprises: generating the code representing an infrastructure configuration, wherein the method further comprises transmitting the code to a cloud system for deployment of cloud infrastructure in accordance with the infrastructure configuration.
11. The method of any of aspects 1-9, wherein the plurality of objects include physical objects or digital media objects.
12. The method of any of aspects 1-8 and 10, wherein the plurality of objects include cloud infrastructure objects relating to at least one of processor resources, storage resources, or database services.
13. The method of any of aspects 1-12, further comprising: receiving, by the offline processing component, feedback relating to interactions of the user device in the online processing component; and updating the multiple-metric efficacy values based on the feedback.
14. One or more non-transitory, computer-readable mediums storing instructions that, when executed by a data processing apparatus, cause the data processing apparatus to perform operations comprising those of any of aspects 1-13.
15. A system comprising one or more processors; and memory storing instructions that, when executed by the processors, cause the processors to effectuate operations comprising those of any of aspects 1-13.
16. A system comprising means for performing any of aspects 1-13.

The foregoing disclosure provides illustration and description, but is not intended to be exhaustive or to limit the implementations to the precise forms disclosed. Modifications may be made in light of the above disclosure or may be acquired from practice of the implementations.

Although particular combinations of features are recited in the claims and/or disclosed in the specification, these combinations are not intended to limit the disclosure of various implementations. In fact, many of these features may be combined in ways not specifically recited in the claims and/or disclosed in the specification.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.”

1. A system using distributed online and offline processing, comprising:
one or more memories; and
one or more processors, communicatively coupled to the one or more memories, configured to cause the system to:
retrieve, from a data node, a dataset indicating a plurality of cloud service groups indicating a plurality of cloud infrastructure objects;
determine, using an offline processing system, first sampling parameters for cloud service groups, second sampling parameters for cloud infrastructure objects, and a plurality of retrieval sets for the plurality of cloud service groups using offline exploration-exploitation sampling that is based on multiple-metric efficacy values,
wherein a multiple-metric efficacy value, of the multiple-metric efficacy values, associated with a cloud infrastructure object, of the plurality of cloud infrastructure objects, is based on a combination of (1) an efficacy metric representing a reward indicating a quantitative measure of engagement with the cloud infrastructure object and (2) a policy metric that biases the multiple-metric efficacy value using a weighting having a value in accordance with whether the cloud infrastructure object belongs to a pool of promoted cloud infrastructure object types such that the multiple-metric efficacy value is higher when the cloud infrastructure object belongs to the pool of promoted cloud infrastructure object types, to artificially enhance an online sampling relevance of the cloud infrastructure object, than when the cloud infrastructure object is outside of the pool of promoted cloud infrastructure object types;
transmit, from the offline processing system and to an online processing system, the first sampling parameters, the second sampling parameters, and the plurality of retrieval sets;
determine, using the online processing system, a selected cloud service group, of the plurality of cloud service groups, by performing online sampling based on the first sampling parameters;
determine, using the online processing system, a cloud infrastructure object ranking in a retrieval set for the selected cloud service group by performing online sampling based on the second sampling parameters; and
generate, based on the cloud infrastructure object ranking, a cloud computing configuration deployable for the selected cloud service group.

2. The system of claim 1, wherein the one or more processors are further configured to cause the system to:
transmit the cloud computing configuration to a cloud system for the selected cloud service group to cause deployment of the cloud computing configuration.

3. (canceled)

4. The system of claim 1, wherein a cloud infrastructure object, of the plurality of cloud infrastructure objects, relates to:
a processor resource,
a memory resource,
a storage resource, or
a database service.

5. The system of claim 1, wherein the one or more processors, to cause the system to determine the first sampling parameters, the second sampling parameters, and the plurality of retrieval sets, cause the system to:
generate a set of object embeddings representative of cloud infrastructure objects in a cloud service group of the plurality of cloud service groups;
cluster the set of object embeddings to obtain a plurality of clusters;
determine the multiple-metric efficacy values based on data associated with the plurality of cloud infrastructure objects; and
perform the offline exploration-exploitation sampling of the plurality of clusters based on the multiple-metric efficacy values to determine the first sampling parameters, the second sampling parameters, and the plurality of retrieval sets.

6. A method using distributed online and offline processing, comprising:
receiving, by an online processing component of a system and from an offline processing component of the system, a plurality of retrieval sets that are based on offline exploration-exploitation sampling that uses multiple-metric efficacy values
wherein the plurality of retrieval sets are from a plurality of clusters of a set of object embeddings representative of a plurality of objects, and
wherein a multiple-metric efficacy value, of the multiple-metric efficacy values, associated with an object, of the plurality of objects, is based on a combination of (1) an efficacy metric representing a reward indicating a quantitative measure of engagement with the object and (2) a policy metric that biases the multiple-metric efficacy value using a weighting having a value in accordance with whether the object belongs to a pool of promoted object types such that the multiple-metric efficacy value is higher when the object belongs to the pool of promoted object types, to artificially enhance an online sampling relevance of the object, than when the object is outside of the pool of promoted object types;
receiving, by the online processing component, information regarding a user device in connection with a request from the user device;
selecting, by the online processing component and based on the information regarding the user device, a retrieval set of the plurality of retrieval sets; and
generating, by the online processing component and based on selecting the retrieval set, code or markup for a user interface of the user device based on the request.

7. The method of claim 6, wherein receiving the plurality of retrieval sets comprises:
receiving the plurality of retrieval sets, first sampling parameters, and second sampling parameters that are based on the offline exploration-exploitation sampling that uses the multiple-metric efficacy values.

8. The method of claim 7, wherein selecting the retrieval set comprises:
selecting the retrieval set based on the information regarding the user device and by performing online sampling using the first sampling parameters.

9. The method of claim 7, further comprising:
determining, by the online processing component, an object ranking in the retrieval set based on the information regarding the user device and by performing online sampling using the second sampling parameters.

10. The method of claim 9, wherein determining the object ranking comprises:
determining, using an affinity model and based on the information regarding the user device, an affinity output relating to objects in the retrieval set; and
determining the object ranking by performing online sampling using the second sampling parameters, and using the affinity output.

11. The method of claim 6, further comprising:
generating, by the offline processing component, the set of object embeddings representative of the plurality of objects;
clustering, by the offline processing component, the set of object embeddings to obtain the plurality of clusters;
determining, by the offline processing component, the multiple-metric efficacy values based on data associated with the plurality of objects; and
performing, by the offline processing component, the offline exploration-exploitation sampling of the plurality of clusters based on the multiple-metric efficacy values to determine sampling parameters and the plurality of retrieval sets.

12. (canceled)

13. The method of claim 6, wherein generating the code or the markup comprises:
generating the markup for a web page,
wherein the method further comprises transmitting the markup for the web page to the user device.

14. The method of claim 6, wherein generating the code or the markup comprises:
generating the code representing an infrastructure configuration,
wherein the method further comprises transmitting the code to a cloud system for deployment of cloud infrastructure in accordance with the infrastructure configuration.

15. The method of claim 6, wherein the plurality of objects include physical objects or digital media objects.

16. The method of claim 6, wherein the plurality of objects include cloud infrastructure objects relating to at least one of processor resources, storage resources, or database services.

17. The method of claim 6, further comprising:
receiving, by the offline processing component, feedback relating to interactions of the user device in the online processing component; and
updating the multiple-metric efficacy values based on the feedback.

18. An apparatus, comprising:
means for receiving a plurality of retrieval sets, first sampling parameters, and second sampling parameters that are based on offline exploration-exploitation sampling that uses multiple-metric efficacy values
wherein the plurality of retrieval sets are from a plurality of clusters of a set of object embeddings representative of a plurality of objects, and
wherein a multiple-metric efficacy value, of the multiple-metric efficacy values, associated with an object, of the plurality of objects, is based on a combination of (1) an efficacy metric representing a reward indicating a quantitative measure of engagement with the object and (2) a policy metric that biases the multiple-metric efficacy value using a weighting having a value in accordance with whether the object belongs to a pool of promoted object types such that the multiple-metric efficacy value is higher when the object belongs to the pool of promoted object types, to artificially enhance an online sampling relevance of the object, than when the object is outside of the pool of promoted object types;
means for selecting a retrieval set of the plurality of retrieval sets by performing online sampling using the first sampling parameters;
means for determining an object ranking in the retrieval set by performing online sampling using the second sampling parameters; and
means for generating code or markup based on the object ranking in the retrieval set.

19. The apparatus of claim 18, wherein the means for determining the first sampling parameters, the second sampling parameters, and the plurality of retrieval sets comprise:
means for clustering the set of object embeddings to obtain the plurality of clusters;
means for determining the multiple-metric efficacy values based on data associated with the plurality of objects; and
means for performing the offline exploration-exploitation sampling of the plurality of clusters based on the multiple-metric efficacy values to determine the plurality of retrieval sets, the first sampling parameters, and the second sampling parameters.

20. (canceled)
